(19) United States
(12) Patent Application Publication
(10) Pub. No.: US 2008/0092007 A1
(43) Pub. Date: Apr. 17, 2008

(54) Data Communication Device And Method

(75) Inventors: Marton W. Takach, Victoria (AU); Brian C. Bell, Victoria (AU)

Correspondence Address: SUGHRUE MION, PLLC, 2100 PENNSYLVANIA AVENUE, N.W., SUITE 800, WASHINGTON, DC, 20037, US

(73) Assignee: SILICON GAP PTY LTD, Templestowe, (AU)

(21) Appl. No.: 11/661,870

(22) PCT Filed: Sep. 5, 2005
(86) PCT No.: PCT/AU05/01288

§ 371 Date: Dec. 19, 2007

(30) Foreign Application Priority Data
Sep. 6, 2004 (AU) 2004905039

(51) Int. Cl. H04L 1/14; G06F 15/16

(52) U.S. Cl. 714/748; 709/201; 714/799; 714/E11.017

(57) ABSTRACT

A method is described for transferring data from an unsecured computer to a secured computer. The method includes transmitting the data and then receiving the data. Next, it is determined if errors were introduced when the data was transmitted by the unsecured computer or received by the secured computer. If an error was introduced when the data was transmitted or received, the data is retransmitted.

### FIELD OF INVENTION

The present invention relates to the field of data communications. In one form, the invention relates to the transfer of data between electronic devices in an unsecured environment. In a particular form, the present invention relates to the transfer of data between an unsecured computer and a secured computer.

It will be convenient to hereinafter describe the invention in relation to data transfer between computers, however it should be appreciated that the present invention is not limited to that use only.

### BACKGROUND ART

The inventor has realised that one of the foremost aspects of computer security is the protection of a computer against undesired data disclosure. Computer security was originally of concern because of requirements to protect government and military classified data. However, with today's industrial espionage and hacker penetrations, computer security is of concern to a significant portion of computer administrators.

The inventor has further realised the following:
One method of preventing undesired data disclosure is to isolate a secured computer from all unsecured computers. Thus, when data needs to be input into the secured computer, a floppy disk or other similar storage device is inserted into an unsecured computer. The unsecured computer then stores the data onto the floppy disk. Next, the floppy disk is removed from the unsecured computer and then transported to the secured computer. Finally, the secured computer reads the data.
The above described method is not considered optimal. Firstly, because the method involves insertion and removal of floppy disks, the method is difficult to automate. While robots may be programmed to perform such tasks, robots are quite expensive. In addition, because of the delays in transferring floppy disks, the secured computer will not have access to real-time or near real-time data. Further, once a floppy disk is inserted into a secured computer, the floppy disk becomes “classified” and may never be used in an unsecured computer again. Hence, if large amounts of data need to be transferred frequently, then large amounts of floppy disks may be consumed. The costs of purchasing and handling such floppy disks may be significant.
Sophisticated methods are currently being used to protect secure computers from undesired data disclosure. Such methods utilize personal transaction devices such as smart cards and tokens, biometric verifiers, port protection devices, encryption, authentication, and digital signature techniques. However, regardless of the type of protective measures utilized, if a secured computer has the ability to transfer data to an unsecured computer, then undesired data disclosure is possible. Because all the above sophisticated methods allow, under limited circumstances, a secured computer to transfer data to an unsecured computer, vulnerabilities exist.
Another method of isolating a secured computer from all unsecured computers is to connect the two systems utilising an optical transmitter and receiver to implement a one way data path. Such systems utilise an infrared or laser light source in conjunction with a light detector. An additional two dedicated computers are used to provide the interface to the optical isolators.
As represented by FIG. 1, the usual method of transferring data from one computer to another is to use a network (LAN). Each computer has a network interface card (NIC). The most common type of NIC is an Ethernet card. All nodes on an Ethernet network, i.e. clients and servers, are connected to the LAN as branches off a common line. Each node has a unique address. When a node, a PC or server needs to send data to another node, it sends the data through a network card. The card listens to make sure no other signals are being transmitted along the network. It then sends its message to another node through the network card's transceiver. Each node's network connection has its own transceiver.
The transceiver broadcasts the message in both directions so that it will reach all other nodes on the network. The message includes the addresses of the message's destination and source, packets of data to be used for error checking and the data itself.
When a node detects its own address in a message, the node reads the data, checks for errors, and sends an acknowledgement to the sender, using the sender's address, which was included as part of the incoming message.
The problem, from a security point of view, is the network, by design, permits bidirectional data flow. A determined “hacker” can bypass security measures designed to protect the network by use of encryption or some form of hiding the address of the destination node. It is then a relatively trivial task to cause the destination node to send data to another unauthorised node using the NIC.

Any discussion of documents, devices, acts or knowledge in this specification is included to explain the context of the invention. It should not be taken as an admission that any of the material forms a part of the prior art base or the common general knowledge in the relevant art in Australia or elsewhere on or before the priority date of the disclosure and claims herein.

An object of the present invention is to provide a method and device that allows real-time or near real-time data to be transferred to a secure computer without enabling the secured computer to transfer data to an unsecured computer and without requiring any additional computers.

A further object of the present invention is to alleviate at least one disadvantage associated with the prior art.

### SUMMARY OF INVENTION

The present invention provides a method of and device for transferring data from an unsecured computer to a secured computer.

In one aspect of invention, there is provided a hardware or digital isolator connectable to a LAN using the standard Ethernet protocol that requires 2 way communication in order to operate, but only allows data to flow in one direction, thereby preventing any data from the destination node from passing to the transmitting node.

This may be accomplished, in one form, by arranging for unidirectional data path between two NIC cards. Each NIC card fulfils the WAN requirement for bi-directional communication, in order to initiate a connection to allow data transfer. A digital isolator is preferably interposed between two network adapters accomplishes the unidirectional flow. The isolator may acts as a virtual air gap as it only allows a signal present on the input to flow to the output.

Another aspect of invention enables the use of a separate port on the hardware isolator that is not connected to the transmitting WAN or the receiving WAN, to set the IP address of the network that is permitted to receive data.

In still another aspect of invention, a method includes transmitting the data and then receiving the data. Next, the data is retransmitted and re-received. Then, it is determined if errors were introduced when the data was transmitted by the unsecured computer or received by the secured computer.

Other aspects and preferred aspects are disclosed in the specification and/or defined in the appended claims, forming a part of the description of the invention.

In essence, the present invention seeks to enable a one-way communication path by only allowing data to flow in one direction, providing a digital isolator, and/or a method of first transmitting and receiving data and thereafter re-transmitting and re-receiving data. Also, a ‘clear to send’ signal is used to indicate that the data has been received correctly and/or has been verified. The ‘clear to send’ signal is a status indictor, not a data path, thus further preventing a path through which unwanted (or unsecured) data can pass between computer and network.

The present invention has been found to result in a number of advantages, such as:
Any of the methods as herein disclosed may be implemented by programming a general or special purpose computer. The programming may be accomplished through the use of a program storage device readable by the general or special purpose computer and encoding a program of statements executable by the computer for performing the operations described above. The program storage device may take the form of one or more floppy disks, a hard disk, a CD ROM or other optical or magnetic-optical disk, a magnetic tape, a read-only memory chip (ROM), and other forms of the kind well known in the art or subsequently developed. The program of statements may be object code, or a high-level language, or in some intermediate form such as partially compiled code. The precise forms of the program storage device and of the encoding of statements are considered relatively immaterial.
Not allowing, under any circumstances, a secured computer to transfer data to an unsecured computer. Thus, one may be assured that no undesired data disclosures will occur.
Enabling real-time or near real-time data transfer. Thus, the secured computer will have access to real-time or near real-time data.
The system is considered to be very economical. Unlike other systems utilising the principles of air gap transmission, it does not require the presence of two additional dedicated computers to interface to the unsecured and secured networks. It is estimated that the hardware may be obtained for less than $100 in production quantities.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

Further disclosure, objects, advantages and aspects of the present application may be better understood by those skilled in the relevant art by reference to the following description of preferred embodiments taken in conjunction with the accompanying drawings, which are given by way of illustration only, and thus are not limitative of the present invention, and in which:

FIG. 1 illustrates an unprotected (prior art) network,

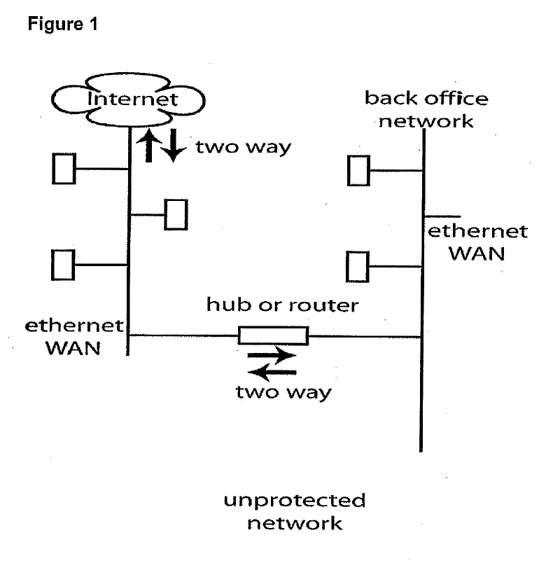

FIG. 2 illustrates a protected network according to one embodiment of the present invention,

FIG. 3 illustrates a secure transfer system according to an embodiment of the present invention,

FIG. 4 illustrates one embodiment of a circuit for converting serial data into magnetic transmissions and back to serial data, and

FIG. 5 illustrates one embodiment of a CPU and UART according to the present invention.

### DETAILED DESCRIPTION

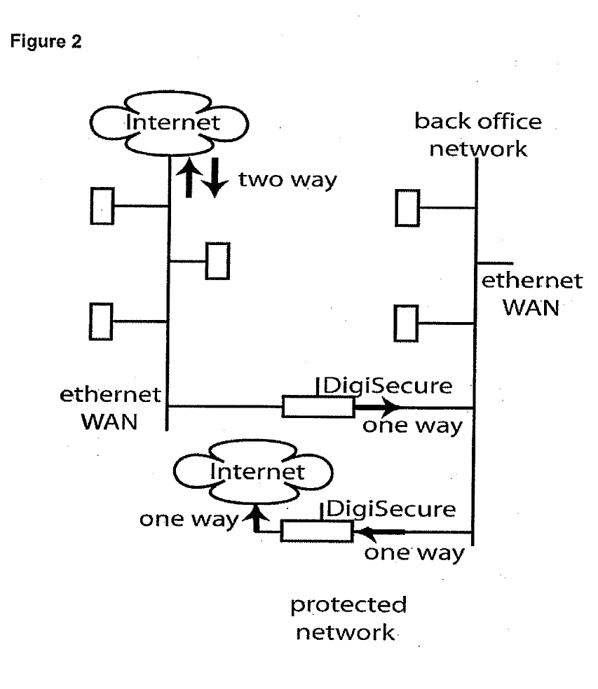

With reference to FIG. 2, a protected network according to one embodiment of the present invention is shown which illustrates an implementation providing a protected network. The present invention provides for a hardware or digital isolator that can be connected to a LAN using the standard Ethernet protocol that requires 2 way communication in order to operate, but only allows data to flow in one direction, thereby preventing any data from the destination node from passing to the transmitting node.

This may be accomplished, in one form, by arranging for unidirectional data path between two NIC cards. Each NIC card fulfils the WAN requirement for bi-directional communication, in order to initiate a connection to allow data transfer. A digital isolator that is interposed between two network adapters accomplishes the unidirectional flow.

This can take the form of magnetic signal isolator that incorporates an actual air gap or silicon chip such as a NAND gate that acts as a virtual air gap as it only allows a signal present on the input to flow to the output. This can take the form of a UART or a combination of such silicon devices in a serial or parallel configuration, as described in this invention.

A further embodiment of this invention is the use of a separate port (shown by the vertical line on the block labelled DigiSecure in FIG. 2) on the hardware isolator that is not connected to the transmitting WAN or the receiving WAN, to set the IP address of the network that is permitted to receive data.

Although, hardware, such as NIC and UART are not new, however the manner of connecting such devices together such that standard network protocols can be used, whilst at the same time ensuring there is no possibility of a bidirectional data flow is the basis of this original claim.

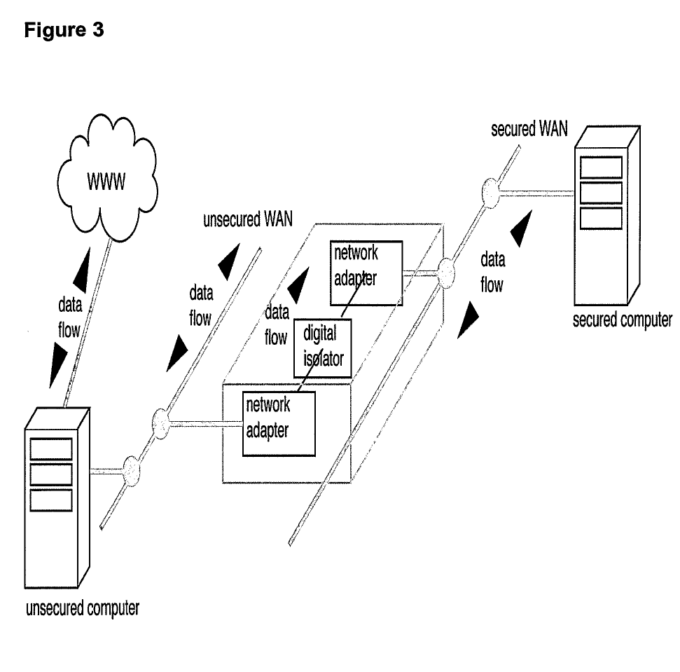

FIG. 3 represents a diagram of a secure transfer system according to one embodiment of the present invention. The secure transfer system includes an unsecured computer, a network interface, digital signal isolator, a network interface, and a secured computer.

### 3.1 UNSECURED COMPUTER

The unsecured computer in the secure transfer system may be any general purpose computer or a communications device. Examples of such computers include: IBM compatible personal computers, Apple computers, computer workstations such as those produced by SUN, DEC, and IBM, and mainframe computers or any electronic-communications device. Alternatively, the unsecured computer may be a special purpose computer such as a micro-controller, a digital signal processor (DSP), or an embedded computer.

Any computer or device will suffice as long as it contains an output port that can be coupled to a network. Common output ports are network adapters using Ethernet protocols.

### 3.2 DIGITAL ISOLATOR

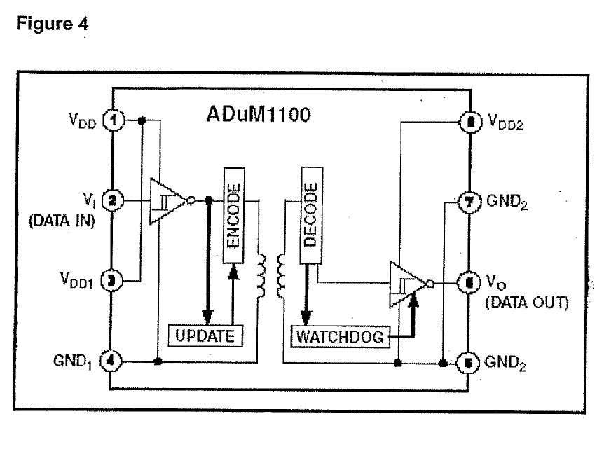

Referring to FIG. 4, the unsecured computer is coupled to a magnetic coupling device or transmitter. The magnetic transmitter receives data from the unsecured computer and transmits the same data magnetically. A primary advantage of using a magnetic isolator is that the transmission is inherently unidirectional. Thus, because no magnetic transmitter is coupled to the secured computer, undesired data disclosure is not possible.

While numerous variations of the magnetic isolator are possible, an integrated circuit device, such as Analog Device's AduM100AR/BR digital isolator, may be optimal in certain circumstances. A circuit for converting serial data into magnetic transmissions is shown in FIG. 4. Circuits for converting serial data into magnetic transmissions are known in the art.

### 3.3 MAGNETIC RECEIVER

Referring again to FIG. 4, a magnetic receiver is placed so that it may receive the magnetic transmissions from the magnetic transmitter. Typically, the magnetic receiver is separated from the magnetic transmitter by an air gap. However, an insulating barrier between the two coils may separate the magnetic receiver and the magnetic transmitter. The device combines high-speed CMOS and monolithic transformer technology to provide digital isolation and a one way data path. The input logic transitions are inductively coupled from the transmitter coil to the receiver coil. This digital isolator is considered to provide outstanding performance characteristics superior to opto-coupler devices.

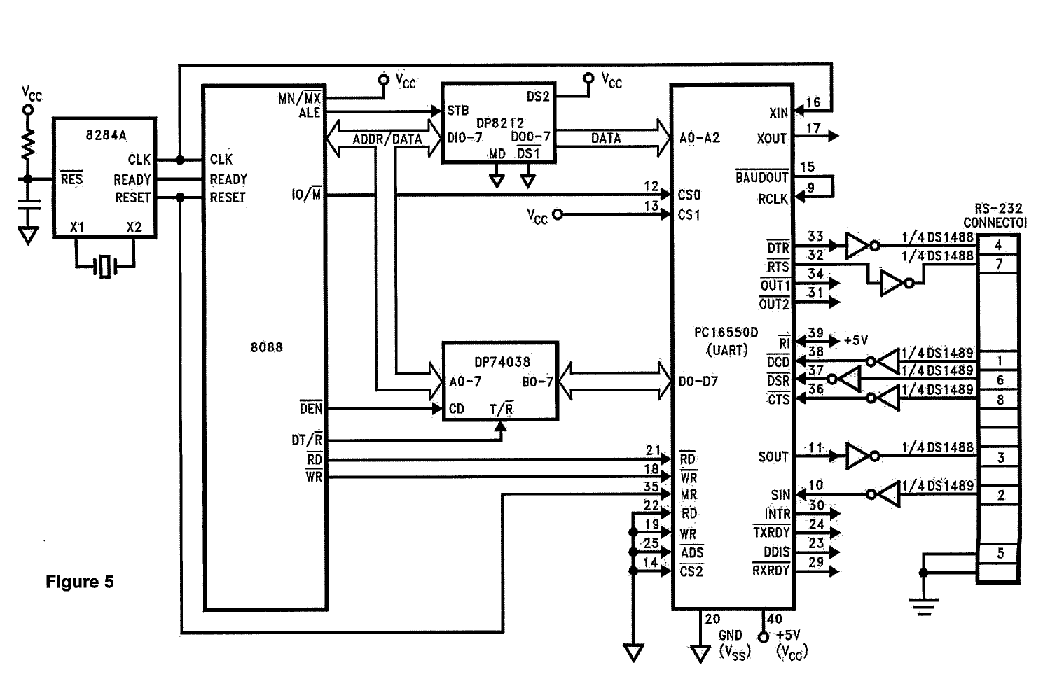

An alternate method for securing digital isolation is to use a serial device, known in the art as a UART (universal asynchronous receiver transmitter). An example of a UART connected to a CPU is shown in FIG. 5. In normal operation, the data out port of the transmitting UART is connected to the data in port of the receiving UART and the data out port of the receiving UART is connected to the data in port of the transmitting UART. In this embodiment of the invention, there is no connection between the data out port of the receiving UART and the data in port of the transmitting UART, thus there can be no return data path from the secure network. Multiple UARTs can also be connected in a parallel configuration to allow for faster data transfer. Other combinations of silicon gates may also be used.

### 3.4 SECURED COMPUTER

Referring again to FIG. 3, a secured computer is coupled to the receiver port of the digital isolator. The secured computer may be any general purpose or special purpose computer as discussed above. Typically, the secured computer will be isolated from all unsecured computers. Any computer will suffice as long as it contains an input port that can be coupled to the optical receiver.

Common input ports include a network adapter using Ethernet protocols.

### 3.5 METHOD OF OPERATION

3.5.1 Transmit the Data

Referring to FIG. 3, the first step in the method is transmitting data from the unsecured computer. Proprietary software on the transmitting computer pipes any data directed to a designated folder on the unsecured computer to a network adapter card. The data stream has the network address of a network adapter designed to listen for Ethernet packages addressed to it. It is designed to pass any data packages it recognises to the data input port of the magnetic digital isolator. The isolated data stream is then passed to a second network adapter which is connected to a secure isolated network.

The data may be any combination of binary bits. In some embodiments, the data may be a single byte. In other embodiments, the data may consist of one or more files of information. The data may contain encrypted information or unencrypted information. In an effort to enable error checking, the data may include parity bits, checksums, error detection codes or error correction codes. Parity bits, checksums, error detection codes, and error correction codes are known in the art.

In accordance with another embodiment, there is a method of transmitting data and then receiving the data. For each data packet, a checksum is calculated and appended to the packet. A checksum is calculated for the data portion of each packet that is received. This is compared to the checksum that is appended to the data packet that was sent. Then, it is determined if the checksums do not match, errors were introduced when the data was transmitted by the unsecured computer or received by the secured computer. Similarly, it is determined if errors were introduced when the unsecured computer retransmitted the data or re-received by the secured computer. If an error was introduced when the data was transmitted or received, the data is retransmitted or re-received. This method has the benefit of minimal overhead on the data transfer rate.

In another step, data from the unsecured computer is translated into a unidirectional signal path and may also be converted from electrical signals into magnetic transmissions.

3.5.2 Receiving the Data

Referring again to FIG. 3, the next step in the method is receiving the transmitted data. In this step, the translated unidirectional data is converted into electrical signals that pass to the secured computer via a bi-directional WAN.

In accordance with the invention, a ‘clear to send’ signal is used to indicate that the data has been received correctly and/or has been verified. The ‘clear to send’ signal is a status indictor, not a data path, thus further preventing a path through which unwanted (or unsecured) data can pass between computer and network.

3.5.3 Retransmitting the Data

If a checksum error is detected at the secured computer end, a request to re-send the packet of data with a detected error is signalled to the unsecured computer. The next step then in the method is retransmitting the data. Thus, the data from the unsecured computer is again converted from electrical signals into unidirectional transmissions.

3.5.4 Re-Receiving the Data

Referring again to FIG. 3, the next step in the method is re-receiving the data. Just as when the data was initially received, the unidirectional transmissions are again converted into electrical signals in the secured computer.

3.5.5 Determining if Errors were Introduced when the Data was Transmitted or Received

Referring again to FIG. 3, the next step in the method is determining if errors were introduced when the data was transmitted or received. This is determined as previously described in the detailed description. This step may be performed by utilizing conventional parity or checksum calculations. Alternatively, conventional error detection or error corrections calculations may be utilized. Further, other error detection calculations that are known in the art may be utilized.

3.5.6 Determining if Errors were Introduced when the Data was Retransmitted or Re-Received

The next step in the method is determining if errors were introduced when the data was retransmitted or re-received. This step may be performed as discussed in section 4.5.5.

3.5.8 Storing the Data

If no errors were introduced when the data was transmitted and received, then the received data may be stored in a storage device in the secured computer. Similarly, if no errors were introduced when the data was retransmitted and re-received, then the re-received data may be stored in a storage device in the secured computer. Common storage devices include floppy disk drives, hard disk drives, CD ROMs or other optical or magnetic-optical disks, and magnetic tapes.

### 3.6 ALTERNATIVE EMBODIMENTS

While the method as disclosed herein indicates retransmitting the data only once, the data may be retransmitted multiple times. These multiple retransmissions and their corresponding receptions increase the opportunities for error free transfers. In some embodiments, data may be retransmitted at predetermined delay intervals.

In one embodiment, the unsecured computer may transmit the transfer time, the transfer date, the file checksum, and/or the file size for each file that is transmitted.

### 3.7 SECURE RETURN COMMUNICATION

It can be advantageous at times to provide a method whereby an acknowledgement or other information is required to be communicated from the secure network to a computer located on the unsecured network.

This can be easily realised if a second digital isolator is used to connect the two networks, but with the reverse signal flow. Because the transmission can only be initiated from the secured network, the manner in which this is done is not visible from the unsecured network, a form of two-way communication can be conducted in a totally secure way.

Since the destination address is set by means of an isolated port on the hardware device, it is impossible for any person with a WAN connection to the secure network to cause data to be sent to some other unauthorised address.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

“Comprises/comprising” when used in this specification is taken to specify the presence of stated features, integers, steps or components but does not preclude the presence or addition of one or more other features, integers, steps, components or groups thereof.” Thus, unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

1. A method for transferring data from an unsecured computer to a secured computer, the method including the steps of:
(a) transmitting the data;
(b) transmitting information validating the data transmitted;
(c) receiving the data;
(d) determining if an error was introduced when the data was transmitted by the unsecured computer or received by the secured computer.

2. A method as claimed in claim 1, further including the steps of:
(e) retransmitting the data;
(f) re-receiving the data;
(g) determining if an error was introduced when the data was retransmitted, by the unsecured computer or re-received by the secured computer.

3. A method as claimed in claim 1, wherein the validating information is a check-sum.

4. A method as claimed in claim 3, wherein the check-sum is calculated in respect of the data in a transmitted packet.

5. A method as claimed in claim 1 or 2, wherein the error is determined with reference to the validating information.

6. A method as claimed in claim 1, further including the step of:
(h) storing the received data on a storage device coupled to the secured computer if an error was not introduced when the data was transmitted or received.

7. A method as claimed in claim 1 or 2, further including the step of:
(h) storing the re-received data on a storage device coupled to the secured computer if an error was not introduced when the data was retransmitted or re-received.

8. A method as claimed in claim 1, wherein the data is transmitted and retransmitted over an air gap.

9. A method as claimed in claim 1, wherein the data is transmitted, at least in part, magnetically.

10. A digital communications network, including:
(i) an unsecured computer;
(ii) a transmitter operatively coupled to the unsecured computer, the transmitter for transmitting and retransmitting data and validation information from the unsecured computer;
(iii) a receiver for receiving data transmitted from the transmitter and for re-receiving data retransmitted from the transmitter;
(iv) a secured computer operatively coupled to the receiver, and
(v) means for verifying the validation information.

11. A network as claimed in claim 10, wherein the transmitter is a magnetic field transmitter.

12. Apparatus adapted to transfer of data from an unsecured computer to a secured computer, said apparatus including:
processor means adapted to operate in accordance with a predetermined instruction set,
said apparatus, in conjunction with said instruction set, being adapted to perform the method as claimed in one of claims 1 or 2.

13. A computer program product including a computer usable medium having computer readable program code and within a data processing system, computer readable system code embodied on said medium for enabling the transfer of data from an unsecured computer to a secured computer, said computer program product including computer readable code within said computer usable medium for facilitating the method as claimed in one of claims 1 or 2.

14. (canceled)

15. (canceled)
